(19) United States
(12) Patent Application Publication
(10) Pub. No.: US 2011/0309555 A1
(43) Pub. Date: Dec. 22, 2011

(54) METHOD FOR THE SOLIDIFICATION OF A NON-METAL MELT

(75) Inventors: Frank Bullesfeld, Kriftel (DE); Uwe Sahr, Nurnberg (DE); Wolfram Miller, Berlin (DE); Peter Rudolph, Schonefeld (DE); Uwe Rehse, Oranienburg (DE); Natascha Dropka, Berlin (DE)

(73) Assignees: FORSCHUNGSVERBUND BERLIN E.V., Berlin (DE); SCHOTT SOLAR AG, Mainz (DE)

(21) Appl. No.: 13/131,637

(22) PCT Filed: Nov. 12, 2009
(86) PCT No.: PCT/EP2009/065063

§ 371 Date: Sep. 12, 2011

(30) Foreign Application Priority Data
Nov. 28, 2008 (DE) 10 2008 059 521.7

(51) Int. Cl. H05B 6/02

(52) U.S. Cl. 264/486

(57) ABSTRACT

A method is proposed for the solidification of a non-metal melt (130) which is located in a crucible (120) arranged in the device (100), wherein the device (100) has a multiplicity of inductors (100) for the creation of magnetic fields. By feeding in a first set of phase-displaced alternating currents (I1a, I2b, I3c, I4d) having a first frequency (f1), a first travelling field (W1) is created in the melt (130). By feeding in at least one second set of phase-displaced alternating currents (I2a, I2b, I3c, I4d) having a second frequency (f2), a second travelling field (W2) is created in the melt (130) which is directed against the first travelling field (W1), wherein the inductors (100) are arranged on the crucible (120) in a vertically extending arrangement, so that the alternating fields created (W1, W2) pass through the melt (130) in vertical direction (Y) and have a flow force minimum on the crucible or vessel wall.

The invention relates to a method according to the preamble of the independent claim. In particular, the invention relates to a method for the directed solidification of a silicon melt.

In the solar industry, it is customary to prepare silicon crystals for the preparation of solar cells by directed solidification. For this, the starting material in granular form is melted in a quartz glass crucible in order to then effect solidification in a directed manner with application of a vertical temperature gradient. The blocks obtained in this way, known as ingots, are sawn into thin silicon discs that can be processed to solar cells in further method steps. The melt crucible is conventionally covered with a layer of Si₃N₄ (see e.g. article “Transition metals in photovoltaic-grade ingot-cast multicrystalline silicon: Assessing the role of impurities in silicon nitride crucible lining material” by T. Buonassis et al, published in the Journal of Crystal Growth, 287 (2006), pages 402-407) which protects the wall of the crucible against the aggressive silicon melt and also facilitates the extraction of the ingot from the crucible after cooling. The convective flow predominating in the melt is substantially determined by the temperature field. However, there are possibilities for influencing the flows, in particular by applying stationary or non-stationary magnetic fields. It is known to create a travelling magnetic field which offers the possibility, with relatively weak field strengths, of bringing a strong influence to bear on the flows in the melt. There is an overview for the application of static and non-static magnetic fields in the crystal growth in the article “Travelling magnetic fields applied to bulk crystal growth from the melt: The step from basic research to industrial scale” by P. Rudolph, published in the Journal of Crystal Growth, 310 (2008), pages 1298-1306.

A method for the electromagnetic stirring of metallic melts is known from patent application DE 35 27 387 A1 in which inductors located on the melt crucible are fed with three-phase currents of different frequencies in order to create magnetic fields which are represented as superimposed rotating fields in azimuthal direction. The arrangement there is provided in the form of a stator winding, as is known from the three-phase motor, in order to express rotating fields rotating in the horizontal plane. These measures are in fact suitable for the electromagnetic stirring of magnetic melts, but they are actually unsuitable for the solidification of non-metal melts which should be carried out in particular in vertical direction.

A device in the form of a furnace and a method for the solidification of a non-metal melt are known from patent application DE 10 2006 020 234 A1. There, a travelling field with three circuit loops which are fed with phase-displaced three-phase currents is created. The circuit loops or inductors are arranged such that they create substantially a vertically moving field. However, a travelling field created in this way forms, particularly on the edge area of the melt crucible, a strong Lorentz force density. This results in a high speed of the melt on the edge of the crucible which in turn has a disadvantageous, in particular eroding, effect on the inner coating of the melt crucible.

Patent application DE 103 49 339 A1 describes a crystal growth system with a heater which at the same time represents an inductor for the creation of a travelling magnetic field. There, the inductor is connected to a power source for three-phase rotary current and thus creates a travelling magnetic field with just one frequency.

Patent application DE 101 02 126 A1 describes a method for the preparation of crystals by drawing from the melt using a one-frequency travelling magnetic field.

Patent application DE 10 2007 020 239 A1 describes a device for the preparation of crystals from electrically conducting melts which contains a multiple reel arrangement as the heating device. The multiple reel arrangement, however, is operated only with one-frequency alternating currents.

The object of the invention is accordingly to overcome the above-named disadvantages in an advantageous manner. In particular, a method of the type named at the beginning should be improved in such a way that the flow distribution and the solidification of a non-metal melt can be carried out in a controlled manner.

The object is achieved by a method with the features of claim 1.

Accordingly, a method for the solidification of a non-metal melt is proposed in which magnetic fields are created by means of a multiplicity of inductors, wherein the inductors are supplied with a first set of phase-displaced alternating currents having a first frequency, so that a first travelling field is created in the melt by superimposition of magnetic fields, and with at least one second set of phase-displaced alternating currents having a second frequency, wherein a second travelling field is created in the melt by superimposition of the magnetic fields created with the second frequency, which is directed against the first travelling field, and wherein the at least two travelling fields created pass through the melt in the opposite direction, preferably in vertical direction.

For this, a multiplicity of inductors are provided for the creation of superimposed magnetic fields, wherein the inductors are supplied with at least two sets of phase-displaced alternating currents which have different frequencies, in order to create a first travelling field and at least one second travelling field in the melt which is directed in an opposite direction to the first travelling field, wherein the inductors are executed on the crucible in an arrangement extending vertically so that the travelling fields created pass through the melt in the opposite direction in vertical direction and the radial field components are reciprocally cancelled or offset each other.

Due to this combination of features, two opposing travelling fields are formed in vertical direction, which leads to the fact that in the edge area a Lorentz force density which leads to a lower speed than in the volume area of the melt, predominates. By adjusting the parameters, in particular by selection of the ratio of the two frequencies, a sufficient distance to the inner wall of the melt crucible at which the maximum Lorentz force density predominates, can be defined.

According to this principle, even more than two travelling fields superimposed in vertical direction can be created.

Preferably, the inductors are developed e.g. as coils, thus as windings circulating in horizontal direction, wherein the windings can be arranged in vertical direction separate from one another or even interlaced in one another in vertical direction. In this context, both the crucible and also the windings and the inner area or diameter of the coils can have a rectangular-shaped cross-section.

Preferably, the inductors can also be supplied with a heating current consisting of alternating current and direct current components for heating the melt. In this context, it is necessary, for the effective creation of the travelling fields, that the heating current has an alternating current component of at least one presettable percentage, in particular of at least 10%.

It is also advantageous if the first frequency and the second frequency differ from one another at most by one presettable factor, in particular by the factor 2-40. The ratio of the frequencies or the factor can be set dependant upon the process, e.g. as a function of the degree of crystallisation.

Preferably, the first and/or second set of phase-displaced alternating currents can also be a plurality of phase-displaced alternating currents non-equidistant to one another.

The invention is suitable in particular for use in a melting furnace or boiler for silicon melts. In this context, the melt crucible can be covered with a protective layer on the inner wall, in particular a layer of Si₃N₄, and developed as a quartz glass crucible.

In the method according to the invention, preferred parameters can be set so that the first frequency and the second frequency, and a first penetration depth and a second penetration depth, fulfil the following equation for the magnetic fields created in each case:

$$D < \frac{ED 1 \cdot ED 2 \cdot ln ( x )}{ED 2 - ED 1} , wherein x = \frac{FD 1 \cdot ED 2}{FD 2 \cdot ED 1} .$$

The penetration depth ED is the distance D from the edge of the crucible at which the Lorentz force density FD has fallen or decreased to 1/e*FD.

The invention and the advantages resulting therefrom are described in detail below by means of exemplary embodiments and with reference to the attached drawings, wherein:

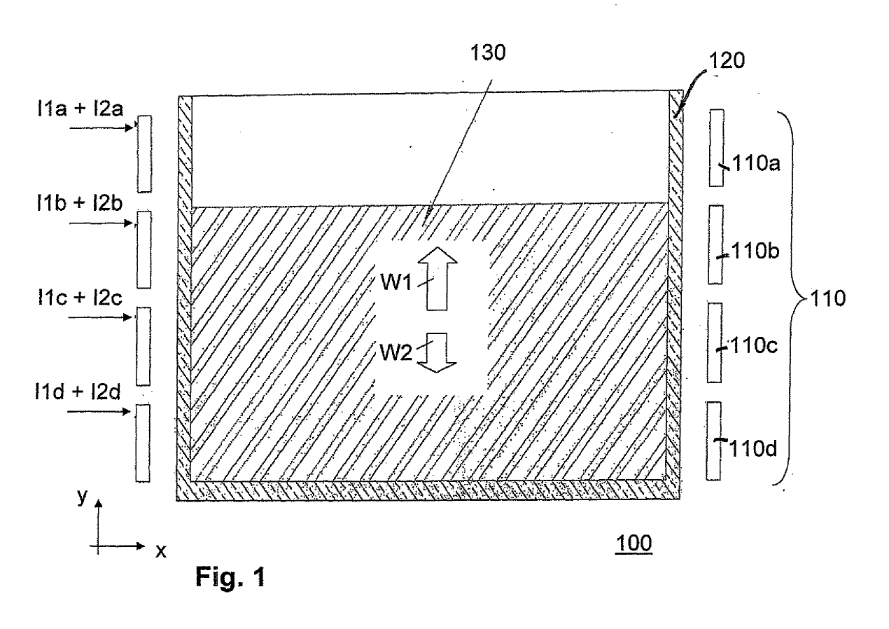

FIG. 1 shows schematically the structure of a device suitable for the performance of the method according to the invention for the solidification of a non-metal melt;

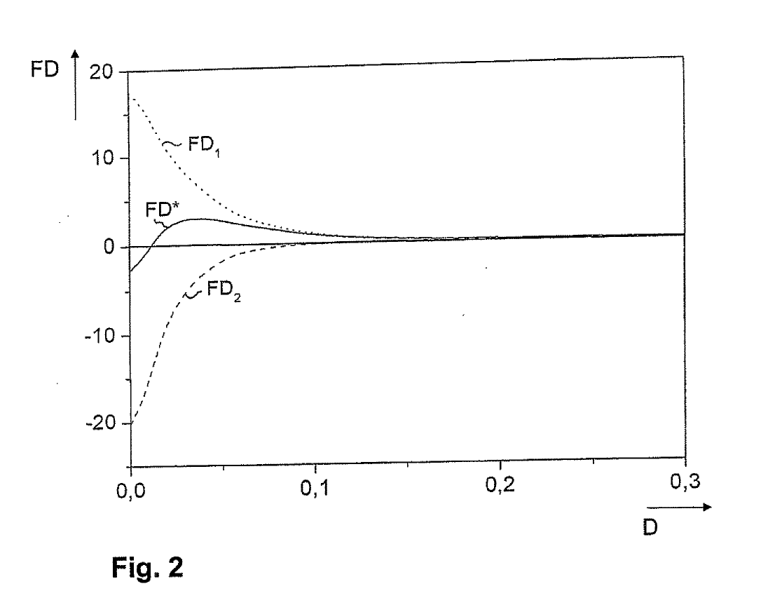

FIG. 2 shows a function diagram with the course of Lorentz force densities as a function of the distance to the wall of the melt crucible; and

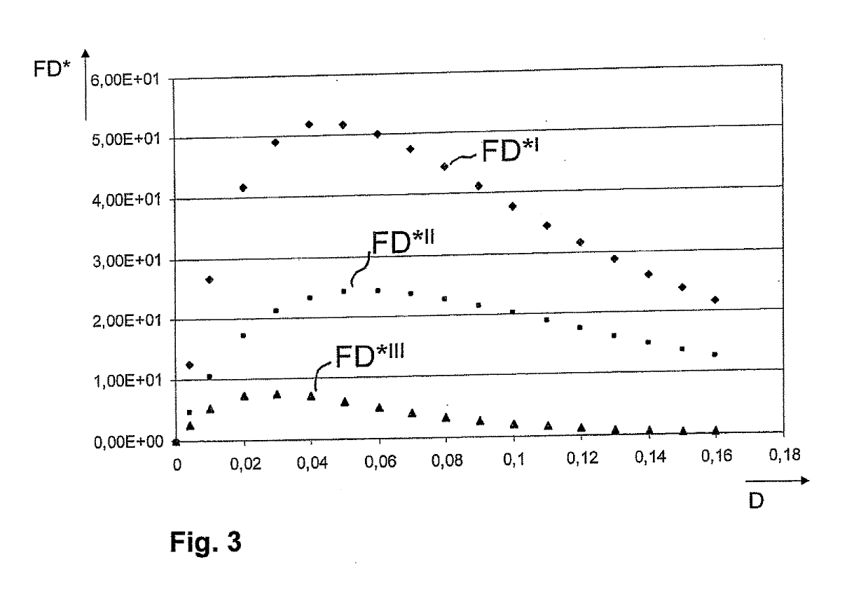

FIG. 3 shows a function diagram with the course of Lorentz force densities in accordance with the method according to the invention.

FIG. 1 shows a schematic representation of a device 100 for the solidification of a non-metal melt 130 which is located in a crucible 120. The melt is for example a silicon melt and the crucible 120 represents a quartz glass crucible, here for example rectangular. On the outside, a plurality of inductors 110 are arranged around the crucible 120 in order to induce magnetic fields into the melt 130 by feeding in alternating currents, so that at least two superimposed travelling fields W1 and W2 move in opposing direction to one another in vertical direction Y. For example, four inductors 110a to 110d are arranged on top of one another in vertical direction Y and are fed with a first set of phase-displaced alternating currents I1a-I1d and with a second set of phase-displaced alternating currents I2a-I2d. The first set of phase-displaced alternating currents is fed with a first frequency f1 which is for example 200 Hz. The second set of phase-displaced alternating currents is fed with a second frequency f2 which is for example 20 Hz.

As is explained by means of FIG. 2, a corresponding superimposition of Lorentz force densities FD1 with FD2 to a resulting Lorentz force density FD* is produced by superimposition of the alternating fields W1 and W2 created in this way. The first Lorentz force density FD1 is created by feeding in the first set of alternating currents I1a-I1d, wherein a relatively high Lorentz force density is set in the edge area of the crucible, i.e. D=0. By feeding in the second set of phase-displaced alternating currents I2a-I2d, a course of the Lorentz force density FD2 which has a negative value in the edge area, i.e. D=0, is produced. By superimposition of FD1 and FD2, a Lorentz force density course FD*, which has a reduced value in the edge area, is therefore produced. By adjusting the parameters, in particular frequencies f1 and f2, according to the invention it is possible to achieve that in the edge area the resulting flow speeds are very low and ideally zero.

FIG. 3 shows the course or waveform of the resulting Lorentz force density FD* with differently adjusted parameters. The top curve FD*′ shows the course of the Lorentz force density when the first frequency f1 is selected at 20 Hz and the corresponding travelling field W1 extends from bottom to top and when the second frequency f2 is selected at 400 Hz, wherein the corresponding travelling field W2 extends from top to bottom. The second curve FD*″ is produced when f1 is equal to 20 Hz and W1 passes from bottom to top and when f2 is equal to 200 Hz and W2 passes from top to bottom. The third curve FD*′″ is produced when f1 is equal to 200 Hz and passes from top to bottom and when f2 is equal to 400 Hz and passes from bottom to top.

As a comparison of the curve courses shows, in all three examples shown the resulting Lorentz force density FD* is clearly reduced in the edge area, i.e. D=0, and is approximately 0 N/m³. By selection of the ratio of f1 to f2, the maximum of the Lorentz force density is displaced inside the melt, i.e. D>0. The second curve FD*″ there has a maximum Lorentz force density in the range D=0.06. In the other curve courses, the maximum is for a smaller distance. Curve course FD*′ has a maximum in the range of D=0.04 and curve course FD*′″ has a maximum in the range D=0.025. Accordingly, the maximum of the Lorentz force density can be displaced particularly widely into the inside of the melt when one of the two frequencies, here f1, is relatively small and is for example 20 Hz and when the other frequency, here f2, is not very much greater, thus e.g. not greater than 40 times that of f1.

By selection of frequencies f1 and f2, it is possible to achieve that the flow speed on the edge of the crucible is quite small and is not greater than 0 to 1 cm/sec. It is also possible to achieve that the flow speed to the inside of the melt, approximately at a distance D=1 cm, is greater than 0.01 to 2 cm/sec. The course of the Lorentz force density and the flow speed or influence on the convection resulting from this can in particular be optimally adjusted by the parameterisation of the frequencies from directions of propagation, phase displacements, amplitudes and geometries of the inductors. To create the travelling fields, the inductors must be fed with relatively high currents of for example 200 A, as a result of which, because of ohmic losses, a heating of the inductors occurs. Instead of leading off this heat using cooling measures, it can also be provided that the inductors are used at the same time as heating elements for the controlled heating of the melt. It is of advantage here if, in addition to the alternating currents which create the travelling fields, another heating current which has only direct current is fed in. The ratio of alternating current components to direct current components can be adjusted as a result of the process.

To create the described function courses of the Lorentz force densities (see FIGS. 2 and 3), the parameterisation of alternating currents I1a-I1d and I2a-I2d above all is required. It has therein been shown that to create a maximum of the Lorentz force density inside the melt, the following condition must be fulfilled:

FD1/FD2>ED1/ED2 and ED2>ED1.

FD1 or FD2 there means the amount of the Lorentz force on the crucible wall and ED1 or ED2 the penetration depth of the magnetic field.

The distance of the maximum Lorentz force occurring from the crucible wall is therein produced by the following relation:

D*<ED1·ED2/(ED2-ED1)·LN(FD1·FD2/FD2·ED1),

wherein D* represents the minimum distance from the wall.

For use of the invention in the melting and solidification of solar silicon in a quartz glass crucible, it has proved particularly advantageous if the maximum of the force field has a distance of approximately 0.1 cm to 40 cm from the wall of the crucible, i.e. D=0.1 to 40 cm.

When power is applied to the inductors or windings, it can also be provided that the phase displacement between the individual windings is non-equidistant. Because the vertical arrangement of the inductors represents substantially a partial section of a linear mode extending in vertical direction to which different types of phase-displaced currents can be applied in sections.

The parameters for a first exemplary embodiment are given using Table 1 below.

TABLE 1

| Winding | 110a | 110b | 110c | 110d |
|---|---|---|---|---|
| f1 in Hz | 200 | 200 | 200 | 200 |
| f2 in Hz | 20 | 20 | 20 | 20 |
| FD1 max. | 0.1 | 0.1 | 0.1 | 0.1 |
| rel. units | | | | |
| FD2 max. | 0.053 | 0.053 | 0.053 | 0.053 |
| rel. units | | | | |
| Phase | 0 | 90 | 180 | 270 |
| displacement | | | | |
| by I1a-d | | | | |
| Phase | 0 | −90 | −180 | −270 |
| displacement | | | | |
| by I2a-d | | | | |

The data for FD1 and FD2 are relative data which relate to a reference variable of X N/m3. The silicon prepared with the given parameters and the solar cells created from this show a clearly higher efficiency than conventional solar cells. In addition, the ingot can be detached from the quartz glass crucible more easily. There are clearly fewer bond points of the ingot to the quartz glass crucible than is conventionally the case. In addition, the melt is clearly less contaminated with components from the crucible material or the coating. The ingot therefore contains fewer separations from foreign phases.

The parameterisation for a further example is given in Table 2 as follows:

TABLE 2

| Winding | 110a | 110b | 110c | 110d |
|---|---|---|---|---|
| f1 in Hz | 100 | 100 | 100 | 100 |
| f2 in Hz | 20 | 20 | 20 | 20 |
| I1 (a-d) in A | 200 | 200 | 200 | 200 |
| I2 (a-d) in A | 200 | 200 | 200 | 200 |
| FD1 max. | 20 | 20 | 20 | 20 |
| rel. units | | | | |
| FD2 max. | 17.5 | 17.5 | 17.5 | 17.5 |
| rel. units | | | | |
| Phase | 0 | 90 | 180 | 270 |
| displacement | | | | |
| by I1 (a-d) | | | | |
| Phase | 0 | −120 | −240 | −360 |
| displacement | | | | |
| by I2 (a-d) | | | | |

The Lorentz force density resulting from this is shown in FIG. 2.

In the magnetic fields created according to the invention, the resulting Lorentz force density thus passes from the edge of the melt to a maximum which is located at a distance D* from the edge area. The course of the Lorentz force density and the position of the maximum can be adjusted in particular by selection of the ratio between the first frequency f1 and the second frequency f2. The arrangement according to the invention is also suitable to be used with rectangular-shaped or square melt crucibles. The windings can in this case likewise run in a rectangular manner on the edge of the crucible without the functioning of the magnetic field creation being disadvantageously influenced by this. The arrangement of the inductors in vertical direction can also be organised interleaved with one another. Preferably, a set of inductors to which power is applied at both frequencies is used. Alternatively, a particular set of inductors can also be provided for each frequency. In addition, the inductors can also be used as heaters. For this, a direct current is also fed in, wherein the alternating current component with f1 and/or f2 is at least 10%. Overall, a very effective device for the solidification of non-metal melts, in particular silicon melts, is produced, wherein a controlled vertical solidification of the melt is made possible.

### LIST OF REFERENCE NUMERALS

100 Device (here: melting furnace) for performing the method
110 Inductors (windings running horizontally)
110a-100d Windings of the inductors
120 Crucible, here quartz glass crucible with inner coating
130 Melt, here silicon melt
I1a-I1d First set of phase-displaced alternating currents
I2a-I2d First set of phase-displaced alternating currents
W1, W2 First or second transformer field (contradirectional)
FD Lorentz force density (in N/m³)
FD1, FD2 Lorentz force density based on the individual transformer fields
FD* Resulting Lorentz force density (due to superimposition); FD*′, FD*″, FD*′″ different runs
D Distance from inner wall of the crucible (in m)
ED Penetration depth of the magnetic field

1. Method for the solidification of a non-metal melt (130) which is located in a crucible (120), in which magnetic fields are created by means of a multiplicity of inductors (100), wherein the inductors (100) are fed with a first set of phase-displaced alternating currents (I1a, I1b, I1c, I1d) having a first frequency (f1), so that by superimposition of magnetic fields a first travelling field (W1) is created in the melt (130), and are supplied with at least one second set of phase-displaced alternating currents (I2a, I2b, I2c, I2d) having a second frequency (f2), characterised in that
by superimposition of the magnetic fields created with the second frequency (f2), a second travelling field (W2) which is directed against the first travelling field (W1) is created in the melt (130), wherein the two travelling fields created (W1, W2) pass through the melt (130) in a substantially vertical direction (Y).

2. Method according to claim 1, characterised in that the inductors (100) are arranged on the crucible (120) in a vertically extending arrangement so that the two travelling fields created (W1, W2) move substantially in vertical direction (Y) in the melt (130).

3. Method according to claim 2, characterised in that a set of inductors (100) is arranged on the crucible (120) which is fed with the alternating currents (I1a, I1b, I1c, I1d; I2a, I2b, I2c, I2d) having the first and the second frequency (f1, f2).

4. Method according to claim 2, characterised in that two sets of inductors are arranged on the crucible, one set of which is fed with the alternating currents having the first frequency and the other set with the alternating currents having the second frequency.

5. Method according claim 1, characterised in that more than two superimposed travelling fields moving substantially in vertical direction are created.

6. Method according to claim 1, characterised in that the inductors (100) are also supplied with a heating current (Ih) consisting of alternating current and direct current components, for heating the melt (130).

7. Method according to claim 6, characterised in that the heating current (Ih) has an alternating current component of at least one presettable percentage, in particular of at least 10%.

8. Method according to claim 6, characterised in that the alternating current component has the at least two frequencies (f1, f2).

9. Method according to claim 1, characterised in that the first frequency (f1) and the second frequency (f2) differ from one another at most by a presettable factor, in particular by a factor of 2 to 40.

10. Method according to claim 1, characterised in that the first and/or second set of phase-displaced alternating currents has a plurality of alternating currents which are non-equidistantly phase-displaced to one another.

11. Method according to claim 1, characterised in that the first frequency (f1) and the second frequency (f2), and a first penetration depth (d1) and second penetration depth (d2), fulfil the following equation for the magnetic fields created by the first or second frequency (f1, f2), respectively:
D<ED1·ED2·ln(X)/(ED2−ED1), wherein X=(FD1·ED2/FD2·ED1) and
D gives a presettable minimum distance to the inner wall of the crucible (120) for a Lorentz force created by the resulting travelling fields (W1, W2).
